(19) United States
(12) Patent Application Publication
(10) Pub. No.: US 2021/0045415 A1
(43) Pub. Date: Feb. 18, 2021

(54) COMPOSITION COMPRISING FISH OIL AND JUICE

(71) Applicant: SMARTFISH AS, Oslo (NO)

(72) Inventor: Janne Sande Mathisen, Oslo (NO)

(21) Appl. No.: 16/828,600

(22) Filed: Mar. 24, 2020

Related U.S. Application Data
(63) Continuation of application No. 12/094,448, filed on Nov. 18, 2008, now abandoned.

(30) Foreign Application Priority Data
Nov. 29, 2005 (NO) 20055620

(51) Int. Cl. A23L 2/02; A23L 2/52; A23L 33/11; A23L 33/115; A23L 33/12

(52) U.S. Cl. CPC A23L 2/02; A23L 2/52; A23L 33/12; A23L 33/115; A23L 33/11

(57) ABSTRACT

The present invention relates to a composition comprising fish oil and juice, to provide a stable oil-in-water emulsion. The fish oil used should have low level of oxidation and a content of omega-3 fatty acids above 16%. The content of fish oil in the composition should be between 0.5-15%.

### 1. FILED OF INVENTION

The present invention relates to a composition containing fish oil and juice and the preparation thereof.

### 2. DESCRIPTION OF PRIOR ART

Fish oil is the richest dietary source of long-chain omega-3 polyunsaturated fatty acids (PUFA). Stabilisation of omega-3 PUFA against oxidation is an important task in food processing.

Fatty acids are the building blocks of dietary fats. The human body stores such dietary fats substantially in the form of triglycerides. Triglycerides containing omega-3 fatty acids are mainly found in fish.

The omega-3 fatty acids are essential to life at any stage, even before birth. They are essential building blocks of the membrane of every cell in the body and their presence are a necessity for maintaining an adequate cell membrane. They do also contribute in the regulation of most biological functions, including those of the cardiovascular, reproductive, immune and nervous systems.

The nutritional value of omega-3 for humans is well known and recognized by scientists and medical skilled persons all over the world. Several studies have been conducted within the field and significant benefits have been revealed on omega-3 in relation to the immune system, on supporting brain development and nervous system. Other studies support benefits of omega-3 intake when suffering from asthma or eczema. There is at present focus on the role of Omega 3 for children suffering from ADHD or other concentration problems.

The typical diet today gives a lack of omega-3. The Health authorities in Norway, Mattilsynet, are now actively advising the public to eat fish for dinner 4 times a week.

Working with marine oil preparations shows that it is extremely difficult to prevent the oxidation of fatty acids. Event thought the processing and storage are conducted in an inert atmosphere, and the product are filled on air tight dose units, it has been difficult to prevent the oxidation completely and to offer a product where the fishy taste is eliminated or fully masked and where the unpleasant aftertaste is no longer present.

Science has long held that damage by oxygen free radicals is behind many of the maladies that come with aging, including cardiovascular disease and cancer. There's firm evidence that a high intake of fruits and vegetables reduces risk of cancer and that a low intake raises risk. And recent evidence suggests that diminished brain function associated with aging and disorders such as Alzheimer's and Parkinson's diseases may be due to increased vulnerability to free radicals, says Joseph, a neuroscientist.

Such evidence has spurred skyrocketing sales of antioxidant vitamin supplements in recent years.

But several large trials testing individual antioxidant vitamins have had mixed results. It may be that combinations of nutrients found in foods have greater protective effects than each nutrient taken alone. Fruits and berries contain hundreds of pigments, as well as non-pigment compounds that may play a role in preventing oxidative damage. The carotenoid pigments lutein and lycopenepossess exceptionally high antioxidant capacity, apricot, peaches and plums have high content of these. For example, fruits and vegetables contain more than 4,000 flavonoids. These constitute a major class of dietary antioxidants and appear to be responsible for a large part of the protective effect of fruits and vegetables.

Since long fish oil have been available on bottles wherein the recommended daily dose is about one spoon. To provide a product with better compliance the fish oil has been encapsulated in different capsules, wherein the recommended daily dose is about 4-6 capsules. Encapsulated products often disguise a heavily oxidized fish oils, and the health value of these oils are questioned by scientist worldwide. Omega-3 enriched capsules are also available.

Prior art the Norwegian Patent Application No 2004 4542 provides a creamy oil-in-water emulsion and Norwegian Patent Application No E41192 provides a drink both containing fish oil, wherein the oxidation of fatty acids is reduced to an acceptable level.

Within the field of functional food, products containing fish oil are available, such as bread and milk preparations etc. Dairy Crest (UK), Dawn Dairies, (Ireland) and Muller Dairies, (UK), lunch of fresh milk or yoghurt drinks added fish oil. The Omega 3 content of these are as follows such that about 1 litre is required to cover the daily dosage requirements of omega-3

In the fresh milk products above the omega-3 source is a pre made emulsion from DSM: ROPUFA 30. This high concentrated emulsion is added to the milk just before the cartons are closed. In Muller Vitality, which was launched November 2005, an omega-3 powder is used. This means the omega-3 fish oil is packed and dried into a powder form, and scientists are discussing whether it is possible for the body to absorb these omega-3 fatty acids.

Products comprising fish oil wherein the oxidation of fish oil has been prevented or minimized by use of antioxidants naturally present in juice, are hitherto not been available.

Thus, there is a need for a stable and tasty composition combining the benefits of fish-oil and naturally occurring antioxidants in the form of juice. The present invention provides such a composition. The composition may be provided as a drink which may be a drink of choice both due to the health promoting effects and when thirsty. The combination may also be provided as creamy or pasty composition, much like yoghurt.

Further, there is a need for a combination of fish oil and fruit juice made into ready-to-use preparations, wherein the process of production involve a minimum of process steps and wherein the fish oil is added directly to the composition, not as a premade emulsion, powder or other intermediates, revealing a gentle process harmless to the fish oil. There is a need for a ready-to-use preparation which provides the consumers with the daily requirement of omega-3 in small units.

### 3. PRESENT INVENTION

Thus the object of the present invention is to provide a new composition combining
a) fatty acids, especially omega-3 fatty acids essential for life in an aliquot sufficient to cover the daily requirement, and
b) juice containing naturally present antioxidants

Another object of the present invention is to provide a new palatable composition comprising fish oil, omega-3 fatty acids and juice in a preparation without any fishy taste or after taste. The term palatable is herein defined as a composition with a pleasant flavor, taste and aftertaste. The content of fish oil in said composition is from 0.5-15% by weight.

A further object of the present invention is to provide a composition containing fish oil, wherein the quality of the refined fish oil as a raw material is excellent.

A further object of the present invention is to provide a method of production wherein the fish oil is handled under gentle conditions through a minimum of process steps.

A further object of the present invention is to provide a stable composition wherein the oxidizing processes of the fatty acids have been lowered to a minimum. The antioxidants of the juice play an important role in preventing oxidation and promoting stability.

A further object of the present invention is to provide a composition in daily dose units containing the recommended daily dose of omega-3 fatty acid. The composition may be provided as a drink in airtight bottles and will contribute to the maintenance of the water balance and be a drink of choice to thirsty people. The composition may also be provided as yoghurt like composition in sealed containers.

These and further objects are achieved by the present invention.

### 4. DETAILED DESCRIPTION OF THE INVENTION

The present invention relates to a new composition comprising fish oil and juice. Through the present invention it has surprisingly been found that the antioxidants naturally present in juice provides a stable oil-in-water emulsion of fish oil, revealing a stable, tasty and user-friendly product. Thus, the present invention provides a new tasty composition containing fish oil and juice.

One preferred embodiment of the present invention provides a composition wherein the content of the fish oil is about 0.5%-15% by weight, more preferably in the range of 2%-7% most preferably about 2%-5%. The fish oil may be selected from any fish oil preparation of appropriate quality. To be of appropriate quality the level of oxidation given as the totox-value (2 times the peroxide value (PV) added with the anisidine value (AV)) should be below 20. Further the content of omega-3 fatty acids should be at least 16%, preferably about 25-30%. Specifically preferred fish oil is Denomega 100 or Denomega Trout oil. Said oils are clear oils with a very mild fishy odour and taste.

By a content of 5% the daily requirement of fish oil are reach by consuming about 50-100 ml of the composition according to the invention. The recommended daily dose of omega-3 for adults are 650 mg given by ISSFAL—International Society for the Study of Fatty Acids. The recommendation for children is about half the dosage of an adult, i.e. 350 mg. There are strong signals from the EU commission that there will be new guidelines on this recommendation. From 2006/2007 the daily dosage requirements will probably be as high as 2 gram. By a content of 5% the daily requirement of fish oil are reach by consuming about 50-100 ml of the composition according to the invention.

Another preferred embodiment of the present invention provides a composition wherein the content of juice is about 30-80% by weight based on the total weight. Preferably, the juice is obtained from fruit and berry having a suitable high level of antioxidants. Further, it is preferred that the fruit possess a minimum level of metal ions functioning as oxidizing agents. Preferred juices may be selected from the group of pomegranat, apricot, grapefruit, orange, cranberry, rosehips, pineapple, black chokeberries, mulberry, cloudberry, acerola, rasberries, watermelon, peaces, grapes, cherries, jambolao, gala apples, mango and kiwi. However, any juice suitable for stabilizing the oxidation of the fish oil may be used. The juice may be prepared by adding water to juice concentrates and juice purée obtaining a normal ready-to use juice. The juice may also be a fresh pressed juice.

Further the composition according to the invention may comprise yoghurt powder. By adding yoghurt powder, the composition thickens giving an inviting consistency. The amount of yoghurt powder may be in the range of 5-10% by weight.

Another preferred embodiment of the present invention provides a composition further comprising sweetener, flavoring agents, antioxidants and preservatives. As such the composition may be given any desirable taste. A suitable emulsifier according to the invention is milk solids, preferably Grindsted FF 1125. However, any suitable emulsifier may be employed. A suitable preservative is potassium sorbate. However any suitable preservative may be employed. A suitable sweetener is xylitol. However any suitable sweetener may be employed.

Especially preferred embodiments of the present invention are compositions comprising a juice selected from the group of rosehips, mango, orange or apple juice or any combination thereof in an amount of about 50% by weight, fish oil in an amount of 2-5% by weight, potassium sorbate as a preservative in an amount of about 0.01-0.1% by weight, tocopherol as a antioxidant in an amount of 0.01-0.1% by weight, xylitol as sweetener in an amount of about 5-8% by weight, milk solid as an emulsifier in an amount of 1-3% by weight, further flavouring agents in an amount of about 0-1% by weight and water to the balance of 100%.

Suitable further flavouring agents are jackfruit and rosemary extract. Additionally, pH regulating agents such as ascorbic acid may be added. Probiotics may also be added.

The consistency of the composition may vary from a liquid drinkable consistence to a more viscous drink, e.g. a smoothie. Further, the consistency of the composition may be creamy like yoghurt.

Another preferred embodiment of the present invention provides a composition wherein the composition is filled in daily dose units, preferably airtight bottles or small sealed containers, but any suitable container may be applicable. Containers containing different amounts of fatty acids adjusted to the recommended daily dose of adults, children and infant are possible. In the case the composition according to the invention is provided as a drink, a suitable volume is 50-200 ml. In the case the composition of the present invention is provided as yoghurt, a suitable volume is 25-100 ml. However, any dose unit covering the recommended daily dose can be applied.

Further, the present invention relates to a process for the preparation the composition according to the invention comprising;
a) water soluble additives are solubilized in water and combined with a suitable juice
b) emulsifier and oil soluble additives are mixed with fish oil of adequate quality under continuous but gentle stirring
c) the oil phase of b) is added slowly under continuous but gentle stirring to the water phase of a) obtaining a homogenous oil-in-water emulsion
d) the composition is filled on suitable air tight sealed containers under inert atmosphere.

It is important to handle the fish oil with care to avoid unnecessary oxidation. As set forth above the fish oil as a starting material fulfills certain specifications with respect to the oxidation parameters. Prior to use the fish oil is stored in containers under inert atmosphere, dark and cold, preferably frozen. Before use the temperature of the fish oil is adjusted to room temperature.

It is important to keep the pH of the composition below 7, preferably about 4-5 to prevent growth of microorganisms.

The processing and packaging are preferably conducted under an inert. The product is stored at a temperature of 0-10° C.

The present invention will now be further described with reference to the following, non-limiting example.

### 5. EMBODIMENTS

### 5.1 Compositions

All compositions were prepared by mixing the juice of choice with the water wherein sweeteners and preservatives are solubilized. The fish oil together with the antioxidants were slowly added under continuous gentle stirring. At last the emulsifier and optionally further flavouring agents were added. When preparing creamy compositions the yoghurt powder was added to the water phase.

All amount are given in percentages based on weight unless otherwise is stated.

Before mixing all ingredients were adjusted to room temperature. The processing and packaging are conducted under an inert atmosphere. The product is stored at a temperature of 0-10° C.

The fish oil “Denomega 100 and Trout oil” are provided by Denomega Nutritional Oils, Øraveien Industripark 2, 1630 Fredrikstad, Norway. Peptigen (whey powder) is provided by Arla. All other ingredients are commercially available by Danisco A/S, Langebrogade 1, DK-1001 Copenhagen.

GRINDSTED® FF 1125 Stabiliser System (E 1422, milk solids, E 1442, E 415)

Jackfruit Flavouring T 10729 (NI, liquid)

GRINDOX™ TOCO 50 Antioxidant (E 306, rapeseed oil)

GUARDIAN™ Rosemary Extract 201 (natural rosemary extract)

### 5.1.1 Drinkable Compositions;

### Containing Omega-3 Fatty Acids and Different Juices

Batch size: 500 gram

| | Example No | | |
|---|---|---|---|
| | 1 | 2 | 3 |
| Composition | % | % | % |
| Water | 38.92 | 38.77 | 38.77 |
| Fish oil, Denomega 100 | 3.00 | 3.00 | 3.00 |
| Rosehips and orange juice | 50.00 | | |
| Mango and orange juice | | 50.00 | |
| Apple (pomegranat) juice | | | 50.00 |
| Jackfruit | | 0.15 | 0.15 |
| Potassium Sorbate | 0.05 | 0.05 | 0.05 |
| Xylitol | 5.00 | 5.00 | 5.00 |
| Grindsted FF 1125 | 2.00 | 2.00 | 2.00 |
| Guardian Rosemary Extract | 0.02 | 0.02 | 0.02 |
| Grindox Toco 20 Antioxidant | 0.01 | 0.01 | 0.01 |
| Peptigen | 1.00 | 1.00 | 1.00 |
| Total | 100.00 | 100.00 | 100.00 |
| pH | 4.8 | 4.5 | 4.8 |

Immediately following production, the drinks had a homogenous appearance indicating a well formed emulsion. The viscosity was low (like juice) leaving drinks which are easy to swallow. No smell or taste of fish oil could be experienced. No fishy aftertaste was experienced.

### 5.1.2. Drinkable Compositions;

### Containing Omega-3 Fatty Acids and Apple Juice, Milk or Probiotics

Batch size: 500 gram

| | Example No | | |
|---|---|---|---|
| | 4 | 5 | 6 |
| Composition | % | % | % |
| Water | 40.77 | 9.77 | 40.77 |
| Fish oil, Trout oil | 2.00 | 3.00 | 3.00 |
| Apple (pomegranat) juice | 50.00 | 50.00 | 50.00 |
| Low fat milk | | 30.00 | — |
| Biogaia L. reuteri | | — | 0.20 |
| Jackfruit | 0.15 | 0.15 | 0.15 |
| Potassium Sorbate | 0.05 | — | 0.05 |
| Xylitol | 5.00 | 5.00 | 5.00 |
| Grindsted FF 1125 | 2.00 | 2.00 | 2.00 |
| Guardian Rosemary Extract | 0.02 | 0.02 | 0.02 |
| Grindox Toco 20 Antioxidant | 0.01 | 0.01 | 0.01 |
| Total | 100.00 | 98.95 | 100.20 |
| pH | 4.2 | 4.8 | 4.2 |

Immediately following production, the drinks had a homogenous appearance indicating a well formed emulsion. The viscosity was low (like juice) leaving drinks which are easy to swallow. No smell or taste of fish oil could be experienced. No fishy aftertaste was experienced.

### 5.1.3 Drinkable Composition;

### Containing Omega-3 Fatty Acids, Juice and Milk

Batch size: 500 g

| | Example No |
|---|---|
| | 7 |
| Composition | % |
| Water | 9.82 |
| Fish oil, Trout oil | 2.00 |
| Juice (pomegranate) | 50.0 |
| Low fat milk | 30.0 |
| Potassium Sorbate | 0.0 |
| Xylitol | 5.0 |
| Grindsted FF 1125 | 2.0 |
| Guardian Rosemary Extract | 0.02 |
| Grindox Toco 20 Antioxidant | 0.01 |
| Peptigen | 1.0 |
| Jackfruit | 0.15 |
| Total | 100.00 |

### 5.1.4. Yoghurt Like Composition;

### Containing Omega-3 Fatty Acids, Apple Juice and Yoghurt Powder

Batch size: 500 gram

| | Example No |
|---|---|
| | 8 |
| Composition | % |
| Water | 26.92 |
| Fish oil, Denomega 100 | 5.00 |
| Apple juice (pomegranate) | 50.00 |
| Yoghurt powder | 10.00 |
| Potassium Sorbate | 0.05 |
| Xylitol | 5.00 |
| Grindsted FF 1125 | 3.00 |
| Guardian Rosemary Extract | 0.02 |
| Grindox Toco 20 Antioxidant | 0.01 |
| Total | 100.00 |

Immediately following production, the composition had a homogenous appearance indicating a well formed emulsion. The consistency was creamy or pasty, leaving a yoghurt like composition easy to swallow. No smell or taste of fish oil could be experienced by a panel of voluntaries testing the composition. No fishy aftertaste was experienced.

### 5.2 Process of Production

The composition according to the invention was prepared by the following steps;
a) water soluble additives are solubilized in water and combined with a suitable juice
b) emulsifier and oil soluble additives are mixed with fish oil of adequate quality under continuous but gentle stirring
c) the oil phase of b) is added slowly under continuous but gentle stirring to the water phase of a) obtaining a homogenous oil-in-water emulsion
d) the composition is filled on suitable air tight sealed containers under inert atmosphere.

The sequence of the steps can be varied as long as a composition of appropriate quality is achieved.

The content of fish oil is preferably between 0.5 and 15%, most preferably between 2-5%. The juice may be any suitable juice as outlined above.

The containers may preferably be small bottles or containers ready to be used. Containers containing different amounts of fatty acids and juice adjusted to the recommended daily dose of adults, children and infant are preferred. The processing and packaging are conducted under an inert atmosphere. The product is stored at a temperature of 0-10° C.

### 5.3 Performance/Stability

As indicated above, all compositions performed excellent immediately after completing the production.

The compositions according to the invention were tested with respect to stability.

### 5.3.1 Long Term Stability

Drinks and yoghurt compositions and stored illuminated at 6° C., resembling the storage conditions in the stores.

The compositions were tested with respect to visual inspection and smell, as well to oxidative status. To evaluate the oxidative status the emulsion must be decomposed to recover the fish. The composition were centrifuged for 1 h at 15 000 rpm. Surprisingly the emulsion did not decompose and thus it was impossible to recover the fish oil for oxidative status. As such this was an eminent proof of the improved stability achieved by the composition according to the invention.

### 5.3.2 14 Days Stability

Drinks comprising rosehip juice and 3% fish oil filled on air tight containers were stored at 25-28° C. for 14 days. The screw-cap of the airtight bottle was removed and the room was illuminated.

After 14 days no changes were observed with respect to the appearance, smell or taste. These findings were surprisingly good and unexpected, as compositions containing fish oil are known to be highly unstable. Thus, a new and inventive fish oil product having surprisingly high stability both with respect to the stability of the emulsion and the stability of the fish oil are provided.

Without being bound to a specific theory, this is believed to be the result of the excellent performance of the juice, the excellent quality of the fish oil as a raw material and the gentle process in which the fish oil is emulsified and prepared into ready-to-use products.

1. A composition comprising a combination of fish oil and juice in an oil-in-water emulsion, wherein said fish oil is selected from fish oil having a totox value below 20 and omega-3 content above 16% by weight.

2. The composition according to claim 1, wherein the totox value is below 5.

3. The composition according to claim 1, wherein the omega-3 content is above 30% by weight.

4. The composition according to claim 1, wherein the content of fish oil is about 0.5 to about 15% by weight based on the total weight.

5. The composition according to claim 1, wherein said juice originates from fruit or berry having natural antioxidants.

6. The composition according to claim 1, wherein the content of juice is about 30-80% by weight based on the total weight.

7. The composition according to claim 1, wherein the juice is selected from the group consisting of pomegranate, apricot, grapefruit, orange, cranberry, rosehips, pineapple, black chokeberries, mulberry, cloudberry, acerola, raspberries, watermelon, peaches, grapes, cherries, jambolao, gala apples, mango, kiwi, and combinations thereof.

8. The composition according to claim 1 further comprising yogurt powder.

9. The composition according to claim 1, further comprising an emulsifier, a sweetener, a flavoring agent, and a preservative.

10. The composition according to claim 9, wherein said emulsifier is milk solids.

11. The composition according to claim 10, wherein said milk solids is GRINDSTED FF 1125.

12. The composition according to claim 9, wherein said preservative is potassium sorbate.

13. The composition according to claim 9, wherein said sweetener is xylitol.

14. The composition according to claim 1, wherein said composition is filled in daily dose units in airtight bottles or sealed containers.

15. The composition according to claim 1 comprising a juice selected from the group consisting of rosehips, mango, orange or apple juice or any combination thereof in an amount of about 50% by weight, fish oil in an amount of 2-5% by weight, potassium sorbate as a preservative in an amount of about 0.01-0.1% by weight, tocopherol as an antioxidant in an amount of about 0.01-0.1% by weight, xylitol as sweetener in an amount of about 5-8% by weight, milk solids as an emulsifier in an amount of 1-3% by weight, optionally further flavoring agents in an amount of about 0-1% by weight and water to the balance of 100%.

16. The composition according to claim 15, comprising further flavouring agent selected from jackfruit and rosemary extract.

17. The composition according to claim 1, wherein the composition is drinkable.

18. A process for the preparation of a ready-to-use composition comprising the steps of:
a) solubilizing water soluble additives in water and combining the water soluble additives with a juice containing natural antioxidant;
b) mixing emulsifier and oil soluble additives with fish oil under continuous but gentle stirring;
c) adding the oil phase of b) slowly under continuous but gentle stirring to the water phase of a) to form a homogenous oil-in-water emulsion; and
d) filling the homogenous oil-in-water emulsion into air tight sealed containers under an inert atmosphere.

19. The process according to claim 18, wherein the fish oil is selected from fish oil having a totox value below 20.

20.-22. (canceled)

23. A sealed container containing a composition as claimed in claim 1.
